(19) United States
(12) Patent Application Publication
(10) Pub. No.: US 2023/0375847 A1
(43) Pub. Date: Nov. 23, 2023

(54) OPTICAL ISOLATOR, ULTRAVIOLET LASER DEVICE, AND ELECTRONIC DEVICE MANUFACTURING METHOD

(71) Applicants: Gigaphoton Inc., Tochigi (JP); Inter-University Research Institute Corporation, National Institutes of Natural Sciences, Tokyo (JP)

(72) Inventors: Yuki TAMARU, Oyama-shi (JP); Taisuke MIURA, Oyama-shi (JP); Ryo YASUHARA, Toki-shi (JP)

(73) Assignees: Gigaphoton Inc., Tochigi (JP); Inter-University Research Institute Corporation, National Institutes of Natural Sciences, Tokyo (JP)

(21) Appl. No.: 18/363,651

(22) Filed: Aug. 1, 2023

Related U.S. Application Data
(63) Continuation of application No. PCT/JP2021/011549, filed on Mar. 19, 2021.

(51) Int. Cl. G02B 27/28; H01S 3/04; H01S 3/225; H01S 3/23

(52) U.S. Cl. CPC G02B 27/28; H01S 3/0401; H01S 3/2251; H01S 3/2256; H01S 3/23

(57) ABSTRACT

An optical isolator includes a first polarizer arranged such that a transmission axis thereof is set to cause a normalized transmittance with respect to incident light having a wavelength of ultraviolet and linear polarization to be 0.9 or more, a Faraday rotator using a Faraday material configured to rotate a polarization direction of light having transmitted through the first polarizer in a first rotation direction by a first rotation amount by a magnetic field and rotate the polarization direction in a second rotation direction opposite to the first rotation direction by a second rotation amount by optical activity or birefringence, and a second polarizer arranged such that a transmission axis thereof is set to cause a normalized transmittance with respect to the incident light having transmitted through the Faraday rotator to be 0.9 or more.

### CROSS-REFERENCE TO RELATED APPLICATIONS

The present application claims the benefit of International Application No. PCT/JP2021/011549, filed on Mar. 19, 2021, the entire contents of which are hereby incorporated by reference.

### BACKGROUND

### 1. Technical Field

The present disclosure relates to an optical isolator, an ultraviolet laser device, and an electronic device manufacturing method.

### 2. Related Art

Recently, in a semiconductor exposure apparatus, improvement in resolution has been desired for miniaturization and high integration of semiconductor integrated circuits. For this purpose, an exposure light source that outputs light having a shorter wavelength has been developed. For example, as a gas laser device for exposure, a KrF excimer laser device for outputting laser light having a wavelength of about 248 nm and an ArF excimer laser device for outputting laser light having a wavelength of about 193 nm are used.

The KrF excimer laser device and the ArF excimer laser device each have a large spectrum line width of about 350 to 400 pm in natural oscillation light. Therefore, when a projection lens is formed of a material that transmits ultraviolet rays such as KrF laser light and ArF laser light, there is a case in which chromatic aberration occurs. As a result, the resolution may decrease. Then, a spectrum line width of laser light output from the gas laser device needs to be narrowed to the extent that the chromatic aberration can be ignored. For this purpose, there is a case in which a line narrowing module (LNM) including a line narrowing element (etalon, grating, and the like) is provided in a laser resonator of the gas laser device to narrow a spectrum line width. In the following, a gas laser device with a narrowed spectrum line width is referred to as a line narrowing gas laser device.

### LIST OF DOCUMENTS

### Patent Documents

Patent Document 1: Japanese Patent Application Publication No. H6-51242

Patent Document 2: Japanese Patent Application Publication No. S61-141189

Patent Document 3: Japanese Patent Application Publication No. 2015-64569

### SUMMARY

An optical isolator according to an aspect of the present disclosure includes a first polarizer arranged such that a transmission axis thereof is set to cause a normalized transmittance with respect to incident light having a wavelength of ultraviolet and linear polarization to be 0.9 or more, a Faraday rotator using a Faraday material configured to rotate a polarization direction of light having transmitted through the first polarizer in a first rotation direction by a first rotation amount by a magnetic field and rotate the polarization direction in a second rotation direction opposite to the first rotation direction by a second rotation amount by optical activity or birefringence, and a second polarizer arranged such that a transmission axis thereof is set to cause a normalized transmittance with respect to the incident light having transmitted through the Faraday rotator to be 0.9 or more.

An ultraviolet laser device according to another aspect of the present disclosure includes an oscillation stage laser configured to output pulse laser light having a wavelength of ultraviolet and linear polarization, an amplifier configured to amplify and output the pulse laser light, and an optical isolator arranged on an optical path between the oscillation stage laser and the amplifier. Here, the optical isolator includes a first polarizer arranged such that a transmission axis thereof is set to cause a normalized transmittance with respect to the pulse laser light output from the oscillation stage laser to be 0.9 or more, a Faraday rotator using a Faraday material configured to rotate a polarization direction of the pulse laser light having transmitted through the first polarizer in a first rotation direction by a first rotation amount by a magnetic field and rotate the polarization direction in a second rotation direction opposite to the first rotation direction by a second rotation amount by optical activity or birefringence, and a second polarizer arranged such that a transmission axis thereof is set to cause a normalized transmittance with respect to the pulse laser light having transmitted through the Faraday rotator to be 0.9 or more.

An electronic device manufacturing method according to another aspect of the present disclosure includes generating laser light amplified by an amplifier using an ultraviolet laser device, outputting the amplified laser light to an exposure apparatus, and exposing a photosensitive substrate to the laser light in the exposure apparatus to manufacture an electronic device. Here, the ultraviolet laser device includes an oscillation stage laser configured to output pulse laser light having a wavelength of ultraviolet and linear polarization, the amplifier configured to amplify and output the pulse laser light, and an optical isolator arranged on an optical path between the oscillation stage laser and the amplifier. The optical isolator includes a first polarizer arranged such that a transmission axis thereof is set to cause a normalized transmittance with respect to the pulse laser light output from the oscillation stage laser to be 0.9 or more, a Faraday rotator using a Faraday material configured to rotate a polarization direction of the pulse laser light having transmitted through the first polarizer in a first rotation direction by a first rotation amount by a magnetic field and rotate the polarization direction in a second rotation direction opposite to the first rotation direction by a second rotation amount by optical activity or birefringence, and a second polarizer arranged such that a transmission axis thereof is set to cause a normalized transmittance with respect to the pulse laser light having transmitted through the Faraday rotator to be 0.9 or more.

### BRIEF DESCRIPTION OF THE DRAWINGS

Embodiments of the present disclosure will be described below merely as examples with reference to the accompanying drawings.

FIG. 1 is a side view schematically showing the configuration of an ultraviolet laser device according to a comparative example.

FIG. 2 is a view showing the problem of the ultraviolet laser device according to the comparative example.

FIG. 3 schematically shows the configuration of an optical isolator according to the comparative example in which return light is suppressed.

FIG. 4 schematically shows the configuration of the optical isolator according to a first embodiment.

FIG. 5 is a table showing preferable ranges of the magnetic field and the thickness of a Faraday material when the wavelength of pulse laser light is the oscillation wavelength of an ArF excimer laser.

FIG. 6 is a table showing preferable ranges of the magnetic field and the thickness of a Faraday material when the wavelength of the pulse laser light is the oscillation wavelength of a KrF excimer laser.

FIG. 7 is a graph showing the relationship between the angular difference between a transmission axis of a polarizer and the polarization direction of the pulse laser light and the extinction ratio, and a graph obtained by converting the extinction ratio into a normalized transmittance.

FIG. 8 schematically shows the configuration of the ultraviolet laser device according to a second embodiment.

FIG. 9 schematically shows the configuration of the ultraviolet laser device according to a third embodiment.

FIG. 10 is a front view of a Faraday rotator applied to the third embodiment.

FIG. 11 is a sectional view taken along line 11-11 of FIG. 10.

FIG. 12 schematically shows the configuration of the ultraviolet laser device according to a fourth embodiment.

FIG. 13 schematically shows the configuration of the ultraviolet laser device according to a fifth embodiment.

FIG. 14 schematically shows the configuration of the ultraviolet laser device according to a sixth embodiment.

FIG. 15 is a top view schematically showing the configuration of an amplification stage laser applied to the sixth embodiment.

FIG. 16 schematically shows a configuration example of an exposure apparatus.

### DESCRIPTION OF EMBODIMENTS

### Contents

1. Description of terms
2. Overview of ultraviolet laser device according to comparative example

2.1 Configuration

2.2 Operation

### 3. Problem

4. First embodiment

4.1 Configuration

4.2 Operation

4.3 Selection example of Faraday material, size thereof, and magnetic flux density of magnetic field
4.3.1 Selection example 1
4.3.2 Selection example 2
4.3.3 Selection example 3

4.4 Preferable ranges of magnetic field and thickness of Faraday material

4.5 Allowable angular difference between transmission axis of polarizer and polarization direction of laser light

4.6 Effect

4.7 Modification

5. Second embodiment

5.1 Configuration

5.2 Operation

5.3 Effect

5.4 Modification

6. Third embodiment

6.1 Configuration

6.2 Operation

6.3 Effect

7. Fourth embodiment

7.1 Configuration

7.2 Operation

7.3 Effect

8. Fifth embodiment

8.1 Configuration

8.2 Operation

8.3 Effect

9. Sixth embodiment

9.1 Configuration

9.2 Operation

9.3 Effect

10. Electronic device manufacturing method
11. Other application examples of optical isolator

### 12. Others

Hereinafter, embodiments of the present disclosure will be described in detail with reference to the drawings. The embodiments described below show some examples of the present disclosure and do not limit the contents of the present disclosure. Also, all configurations and operation described in the embodiments are not necessarily essential as configurations and operation of the present disclosure. Here, the same components are denoted by the same reference numerals, and duplicate description thereof is omitted.

### 1. Description of Terms

“Polarizer” refers to an optical element that separates light having a specific polarization direction (transmission axis direction) and light whose polarization direction is perpendicular thereto.

In the present specification, unless otherwise clear from the context, the term “parallel” is not limited to the case of being strictly parallel, and includes the concept of being substantially parallel including a range of angular difference that is practically acceptable without losing technical significance, unless otherwise specified. Further, in the present specification, unless otherwise clear from the context, the term “orthogonal” or “perpendicular” is not limited to the case of being strictly orthogonal or perpendicular, and includes the concept of being substantially orthogonal or substantially perpendicular including a range of angular difference that is practically acceptable without losing technical significance, unless otherwise specified.

### 2. Overview of Ultraviolet Laser Device According to Comparative Example

### 2.1 Configuration

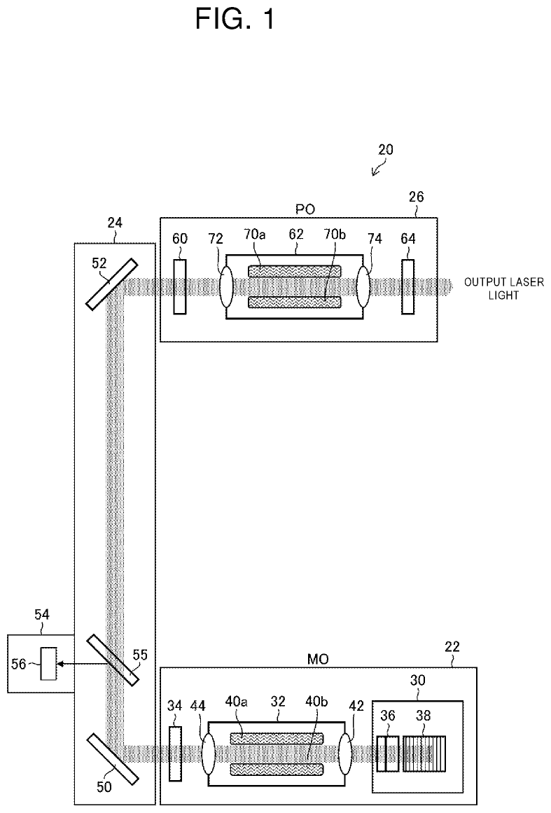

FIG. 1 is a side view schematically showing the configuration of an ultraviolet laser device 20 according to a comparative example. The comparative example of the present disclosure is an example recognized by the applicant as known only by the applicant, and is not a publicly known example admitted by the applicant.

The ultraviolet laser device 20 is an excimer laser device including a master oscillator (MO) 22, an MO beam steering unit 24, and a power oscillator (PO) 26. The MO 22 includes a line narrowing module (LNM) 30, a chamber 32, and an output coupling mirror 34.

The LNM 30 includes a prism expander 36 for narrowing the spectrum line width and a grating 38. The prism expander 36 and the grating 38 are arranged in the Littrow arrangement so that an incident angle and a diffraction angle coincide with each other. The output coupling mirror 34 is a partial reflection mirror having a reflectance of 40% to 60%. The output coupling mirror 34 is arranged to configure an optical resonator together with the LNM 30.

The chamber 32 is arranged on the optical path of the optical resonator. The chamber 32 includes a pair of discharge electrodes 40a, 40b and two windows 42, 44 through which laser light is transmitted. The chamber 32 is filled with a laser gas. The laser gas includes a rare gas, a halogen gas, and a buffer gas. The rare gas may be, for example, an argon (Ar) gas or a krypton (Kr) gas. The halogen gas may be, for example, a fluorine (F₂) gas. The buffer gas may be, for example, a neon (Ne) gas. A voltage is applied between the discharge electrodes 40a, 40b by a power source (not shown). The power source may be a pulse power module (PPM) including a switch and a charging capacitor.

The MO beam steering unit 24 includes a high reflection mirror 50 and a high reflection mirror 52, and is arranged such that the laser light output from the MO 22 enters the PO 26.

An MO pulse energy monitor 54 is arranged between the high reflection mirror 50 and the high reflection mirror 52. The MO pulse energy monitor 54 includes a beam splitter (BS) 55 and an optical sensor 56. The BS 55 is arranged on the optical path of the pulse laser light output from the MO 22 such that the reflection light from the BS 55 enters the optical sensor 56.

The PO 26 is an amplification stage laser including a rear mirror 60, a chamber 62, and an output coupling mirror 64. The rear mirror 60 and the output coupling mirror 64 configure an optical resonator, and the chamber 62 is arranged on the optical path of the optical resonator.

The configuration of the chamber 62 may be similar to that of the chamber 32. The chamber 62 includes a pair of discharge electrodes 70a, 70b and two windows 72, 74. The chamber 62 is filled with a laser gas. The rear mirror 60 may be a partial reflection mirror having a reflectance of, for example, 50% to 90%. The output coupling mirror 64 may be a partial reflection mirror having a reflectance of 10% to 30%.

### 2.2 Operation

High voltage pulses are applied between the discharge electrodes 40a, 40b in the chamber 32 by the power source (not shown). When discharge occurs between the discharge electrodes 40a, 40b in the chamber 32, the laser gas is excited, and pulse laser light having an ultraviolet wavelength of 150 nm to 380 nm as being line-narrowed by the optical resonator configured by the output coupling mirror 34 and the LNM 30 is output from the output coupling mirror 34.

The energy of the pulse laser light output from the output coupling mirror 34 is measured by the MO pulse energy monitor 54. The pulse laser light is incident on the rear mirror 60 of the PO 26 as seed light by the MO beam steering unit 24.

At the timing when the seed light having transmitted through the rear mirror 60 enters the chamber 62, high voltage pulses are applied between the discharge electrodes 70a, 70b in the chamber 62 by the power source (not shown). When discharge occurs between the discharge electrodes 70a, 70b in the chamber 62, the laser gas is excited, the seed light is amplified by a Fabry-Perot optical resonator configured by an output coupling mirror 64 and a rear mirror 60, and the amplified pulse laser light is output from the output coupling mirror 64 as output laser light.

### 3. Problem

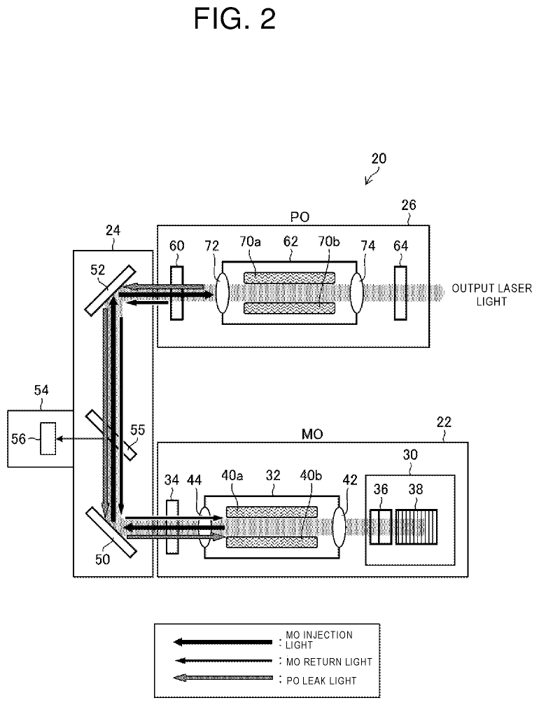

FIG. 2 is a view showing the problem of the ultraviolet laser device 20 according to the comparative example. If return light from the PO 26 returns to the MO 22, the laser performance deteriorates. The term “return light” as used herein refers to the sum of two types of light, that is, MO return light and PO leak light. Light output from the MO 22 enters the PO 26. However, since the rear mirror 60 in the PO 26 is a partial reflection mirror (having a reflectance of 50% to 90%), a part of the light incident on the rear mirror 60 returns to the MO 22 without being directed to the inside of the PO 26. The light that is reflected by the rear mirror 60 and returns to the MO 22 side without traveling into the chamber 62 of the PO 26 is referred to as “MO return light.”

On the other hand, the light that enters the PO 26 from the MO 22 and is transmitted through the rear mirror 60 is resonated and amplified in the PO 26 and then output. As described above, since the rear mirror 60 in the PO 26 is a partial reflection mirror, a part of the light having entered the chamber 62 of the PO 26 and amplified returns to the MO 22. The light that is transmitted through the rear mirror 60 and returns to the MO 22 among the light amplified by the PO 26 is referred to as “PO leak light.”

The return light becomes a thermal load for the LNM 30 and the like, and may cause deterioration in the stability of the line width, the stability of the pulse energy, and the like. In order to suppress the return light entering the MO 22, there is a method of arranging an optical isolator between the MO 22 and the PO 26.

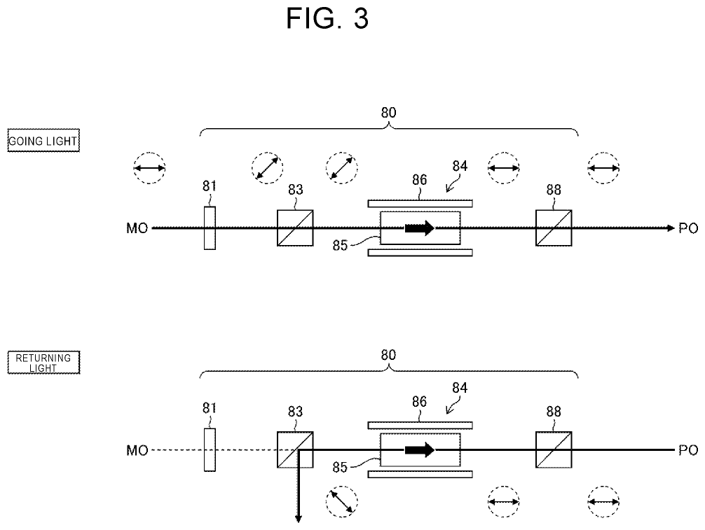

FIG. 3 shows a configuration example of an optical isolator 80 according to a comparative example in which return light is suppressed. The optical isolator 80 is arranged between the MO 22 and the PO 26. The upper part of FIG. 3 shows the operation of the optical isolator 80 with respect to the pulse laser light (MO injection light: going light) traveling from the MO 22 toward the PO 26. The lower part of FIG. 3 shows the operation of the optical isolator 80 with respect to the laser light (returning light) traveling from the PO 26 toward the MO 22.

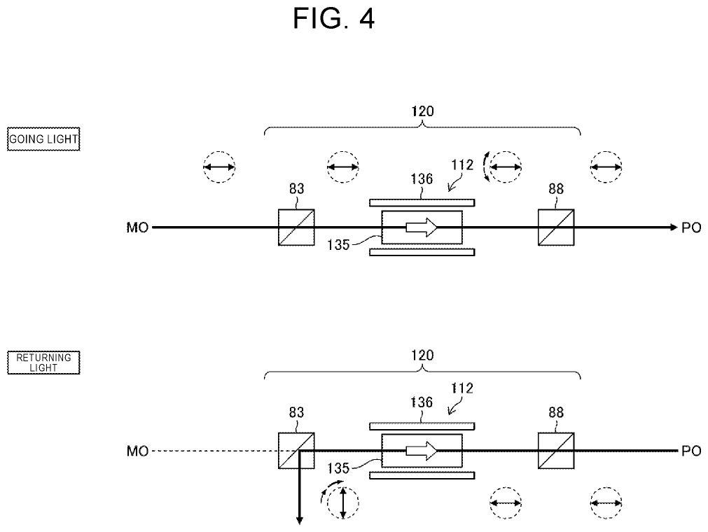

In the optical isolator 80, a half-wave plate 81, a first polarizer 83, a Faraday rotator 84, and a second polarizer 88 are arranged in this order from the MO 22 side. The Faraday rotator 84 includes a Faraday material 85 and a magnet 86. In FIG. 3, rightward arrows shown in the Faraday rotator 84 indicate the direction of the magnetic field by the magnet 86. Double-headed arrows shown in broken line circles in FIG. 3 each indicate the direction of the polarization plane of the pulse laser light when the line of sight is aligned with the direction in which the pulse laser light travels, that is, the polarization direction. The same applies to FIG. 4.

As shown in the upper part of FIG. 3, linearly polarized pulse laser light that is horizontally polarized is output from the MO 22. The polarization direction of the horizontally polarized pulse laser light output from the MO 22 is rotated by 45 degrees in the counterclockwise direction by the half-wave plate 81. The transmission axis of the first polarizer 83 is arranged parallel to the polarization direction of the pulse laser light output from the half-wave plate 81, and the pulse laser light output from the half-wave plate 81 is transmitted through the first polarizer 83.

The polarization direction of the pulse laser light having transmitted through the first polarizer 83 is rotated by 45 degrees in the clockwise direction by the Faraday rotator 84 to which the magnetic field is applied. As a result, the pulse laser light output from the Faraday rotator 84 becomes horizontally polarized light. The transmission axis of the second polarizer 88 is arranged parallel to the polarization direction of the pulse laser light output from the Faraday rotator 84, and the pulse laser light output from the Faraday rotator 84 is transmitted through the second polarizer 88 and then enters the PO 26.

The half-wave plate 81 adjusts the polarization direction of the pulse laser light output from the MO 22 so that the polarization direction of the pulse laser light output from the MO 22 and the polarization direction of the pulse laser light entering the PO 26 become the same. Thus, it is not necessary to change other modules which depend on the polarization direction.

On the other hand, as shown in the lower part of FIG. 3, the return light from the PO 26 is transmitted through the second polarizer 88 with the same polarization direction as the incident light to the PO 26, and the polarization direction is rotated by 45 degrees in the clockwise direction by the Faraday rotator 84 to which the magnetic field is applied. The polarization direction of the return light having transmitted through the Faraday rotator 84 is perpendicular to the transmission axis of the first polarizer 83, and the return light is reflected by the first polarizer 83 and does not enter the MO 22. The half-wave plate 81 of the optical isolator 80 according to the comparative example has low durability at short wavelengths such as for excimer lasers, and is difficult to stably use for a long period of time.

### 4. First Embodiment

### 4.1 Configuration

FIG. 4 schematically shows the configuration of an optical isolator 120 according to a first embodiment. The configuration shown in FIG. 4 will be described in terms of differences from the configuration shown in FIG. 3. The optical isolator 120 does not use the half-wave plate 81 described in FIG. 3, and the first polarizer 83, a Faraday rotator 112, and the second polarizer 88 are arranged in this order from the MO 22 side on the optical path between the MO 22 and the PO 26.

The first polarizer 83 is arranged such that the transmission axis thereof is parallel to the polarization direction of the pulse laser light output from the MO 22 polarized in a specific direction.

The Faraday rotator 112 includes a Faraday material 135 and a magnet 136. The Faraday material 135 is a material that is transparent at the used wavelength and has optical activity or birefringence. The Faraday material 135 is, for example, a quartz crystal or magnesium fluoride (MgF₂). The magnet 136 has a hollow structure, and the application direction of the magnetic field is parallel to the propagation direction of the light. For example, the application direction of the magnetic field is the direction of the arrows shown in the Faraday rotator 112 in FIG. 4.

The second polarizer 88 is arranged such that the transmission axis thereof is parallel to the polarization direction of the pulse laser light output from the Faraday rotator 112 toward the PO 26.

### 4.2 Operation

Since the Faraday material 135 has optical activity or birefringence, the polarization plane is rotated by the Faraday effect when a magnetic field is applied, and the polarization plane is rotated by optical activity or birefringence.

In the optical isolator 120 according to the first embodiment, as shown in the upper part of FIG. 4, the magnetic flux density of the magnetic field and the thickness of the Faraday material 135 are selected such that the polarization plane of the going light is rotated by +45 degrees (or −45 degrees) by the Faraday effect and the polarization plane is rotated by −45 degrees (or +45 degrees) ±180×n degrees by optical activity or birefringence when the going light is transmitted through the Faraday material 13. Here, n is an integer.

In other words, the magnetic flux density of the magnetic field to be applied and the thickness of the Faraday material 135 are selected such that the rotation angle of the polarization plane due to the Faraday effect and the rotation angle of the polarization plane due to optical activity or birefringence are canceled out in the going light. When the Faraday rotator 112 satisfying such a condition is used, the polarization direction does not change before and after the transmission through the Faraday rotator 112.

In the example shown in FIG. 4, in the “going light” that is transmitted through the Faraday rotator 112 in the direction from the MO 22 to the PO 26, the rotation of the polarization plane due to the Faraday effect (rotation of 45 degrees in the clockwise direction) and the rotation of the polarization plane due to optical activity or birefringence (rotation of 45 degrees in the counterclockwise direction) are rotations in opposite directions and are mutually canceled out, and the polarization direction is maintained the same before and after the transmission through the Faraday rotator 112. In the upper part of FIG. 4 showing the polarization direction of the pulse laser light output from the Faraday rotator 112, a thick arc arrow showing a state of rotating 45 degrees in the clockwise direction along a broken line circle represents the rotation of the polarization plane due to the Faraday effect. Further, a thin arc arrow showing a state of rotating 45 degrees in the counterclockwise direction in the upper part of FIG. 4 represents the rotation of the polarization plane due to optical activity or birefringence. Thus, the pulse laser light output from the MO 22 is transmitted through the first polarizer 83, the Faraday rotator 112, and the second polarizer 88, and enters the PO 26.

The Faraday effect is non-reciprocal with respect to the travel direction of the light because the rotation direction of the polarization plane depends on the application direction of the magnetic field and not on the propagation direction of the light. On the other hand, since the rotation direction of the polarization plane due to optical activity or birefringence depends on the propagation direction of light, it is reciprocal with respect to the travel direction of the light.

Therefore, as shown in the lower part of FIG. 4, after the return light from the PO 26 is transmitted through the Faraday rotator 112, the polarization direction is rotated by 90 degrees in the clockwise direction, and the return light is reflected by the first polarizer 83. In the example shown in FIG. 4, in the return light from the PO 26, the rotation of the polarization plane due to the Faraday effect (rotation of 45 degrees) and the rotation of the polarization plane due to optical activity or birefringence (rotation of 45 degrees) are rotations in the same direction and the rotation angles thereof overlap each other, so that the polarization direction after the transmission through the Faraday rotator 112 is rotated by 90 degrees with respect to that before the transmission therethrough. In the lower part of FIG. 4 showing the polarization direction of the returning pulse laser light that is transmitted through the Faraday rotator 112, a thick arc arrow showing a state of rotating 45 degrees in the clockwise direction along a broken line circle represents the rotation of the polarization plane due to the Faraday effect. Further, a thin arc arrow showing a state of rotating 45 degrees in the clockwise direction in the lower part of FIG. 4 represents the rotation of the polarization plane due to optical activity or birefringence. Thus, the pulse laser light returning from the PO 26 is reflected by the first polarizer 83 after being transmitted through the Faraday rotator 112, and is suppressed from entering the MO 22.

The rotation direction of the polarization plane due to the Faraday effect of the Faraday rotator 112 shown in FIG. 4 is an example of the “first rotation direction” in the present disclosure. Further, the rotation direction of the polarization plane due to optical activity or birefringence of the Faraday material 135 with respect to the pulse laser light traveling from the first polarizer 83 toward the second polarizer 88 is an example of the “second rotation direction” in the present disclosure.

### 4.3 Selection Example of Faraday Material, Size Thereof, and Magnetic Flux Density of Magnetic Field

### 4.3.1 Selection Example 1

As the Faraday material 135, a material having optical activity such as a quartz crystal or a material having birefringence such as MgF₂ is selected. For example, when the wavelength of the pulse laser light is 193 nm and the quartz crystal is selected as the Faraday material 135 of the Faraday rotator 112, the specific rotation ρ is 331.85 deg/mm and the Verdet constant V is 70.1 rad/Tm.

An amount of rotation θρ of the polarization plane due to optical activity is expressed by Equation (1).

θρ=ρL (1)

In Equation (1), L is the medium length, and is the length of the quartz crystal (thickness in the optical axis direction) in the present example.

Further, an amount of rotation θv of the polarization plane due to the Faraday effect is expressed by Equation (2).

θv=VBL (2)

In Equation (2), B is the magnetic flux density of the applied magnetic field.

For example, assuming that the length of the quartz crystal is 11.53 mm and the magnetic flux density of the applied magnetic field is 0.97 T, the amount of rotation θρ of the polarization plane due to optical activity is 3825 degrees (=45+180×21 degrees) from Equation (1). The amount of rotation θv of the polarization plane due to the Faraday effect is 45 degrees from Equation (2). Therefore, by applying the magnetic field such that the direction in which the polarization plane rotates due to the Faraday effect is opposite to the direction in which the polarization plane rotates due to optical activity, it is possible to prevent the polarization direction from changing before and after the transmission through the Faraday rotator 112.

Here, 45 degrees exemplified as the rotation amount of the polarization plane due to the Faraday effect is an example of the “first rotation amount” in the present disclosure. Further, 3825 degrees exemplified as the rotation amount of the polarization plane due to optical activity is an example of the “second rotation amount” in the present disclosure.

### 4.3.2 Selection Example 2

When the wavelength of the pulse laser light is 193 nm and MgF₂ is selected as the Faraday material 135 of the Faraday rotator 112, the refractive indices of the ordinary ray and extraordinary ray are as follows.
No=1.4277
Ne=1.4414

Here, No is the refractive index of the ordinary ray, and Ne is the refractive index of the extraordinary ray.

In order to cause the rotation of the polarization due to the birefringence, thickness d of the Faraday material 135 is set such that δ=180+m×360 degrees (m is an integer) is satisfied in Equation (3) described below.

δ(λ)=Δn(λ)×d×(360/λ) (3)

Here, Δn=Ne−No. λ is the wavelength.

With a phase difference of 180 degrees, when the optical axis of the Faraday material 135 is rotated by θ, the polarization is rotated by 2θ.

Further, the Verdet constant V for MgF₂ at the wavelength of 193 nm is 38.1 rad/Tm. Therefore, for example, the above can be achieved by setting the thickness (medium length) L of MgF₂ in the optical axis direction to 20.62 mm and the magnetic flux density B of the applied magnetic field to 1.00 T.

### 4.3.3 Example 3

When the wavelength of the pulse laser light is 248 nm and the quartz crystal is selected as the Faraday material 135 of the Faraday rotator 112, the specific rotation ρ is 157.45 deg/mm and the Verdet constant V is 30.4 rad/Tm.

For example, assuming that the length of the quartz crystal is 26.58 mm and the magnetic flux density of the applied magnetic field is 0.97 T, the amount of rotation θρ of the polarization plane due to optical activity is 4185 degrees (=45+180×23 degrees) from Equation (1). The amount of rotation θv of the polarization plane due to the Faraday effect is 45 degrees from Equation (2). Therefore, by applying the magnetic field such that the direction in which the polarization plane rotates due to the Faraday effect is opposite to the direction in which the polarization plane rotates due to optical activity, it is possible to prevent the polarization direction from changing before and after the transmission through the Faraday rotator 112.

### 4.4 Preferable Ranges of Magnetic Field and Thickness of Faraday Material

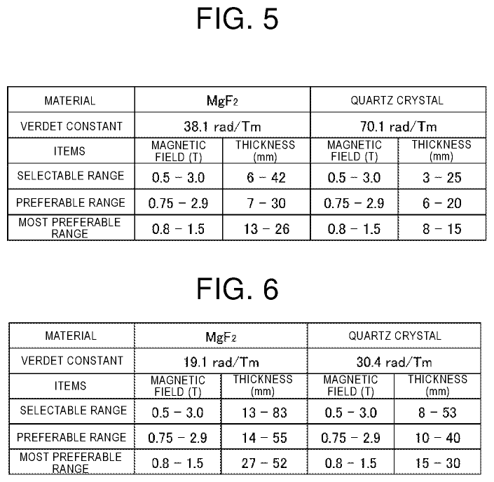

Preferable ranges of the magnetic field and the thickness of the Faraday material 135 are shown in FIGS. 5 and 6 for the case in which the Faraday material 135 is MgF₂ and for the case in which the Faraday material 135 is the quartz crystal. FIG. 5 shows the preferable ranges when the wavelength of the incident light is 193 nm, and FIG. 6 shows the preferable ranges when the wavelength of the incident light is 248 nm. The oscillation wavelength of an ArF excimer laser includes the wavelength of 193 nm. The oscillation wavelength of an KrF excimer laser includes the wavelength of 248 nm.

The preferable ranges were selected based on the ease of realization of the magnetic field. The magnetic field in the most preferable range has the magnetic flux density as using a neodymium magnet or the like having a strong magnetic force. The thickness of the Faraday material 135 is a value obtained by calculating, based on the selected material, the magnetic flux density of the magnetic field, and the Verdet constant, the thickness at which the rotation of the polarization plane due to the Faraday effect and the rotation of the polarization plane due to optical activity or birefringence are 45 degrees, respectively.

As shown in FIG. 5, when the Faraday material 135 is MgF₂ and the wavelength of the pulse laser light is 193 nm, which is the oscillation wavelength of the ArF excimer laser, the selectable ranges of the magnetic field applied to the Faraday rotator 112 and the thickness of the Faraday material 135 in the optical axis direction are 0.5 T-3.0 T and 6 mm-42 mm, respectively. More preferably, the ranges are 0.75 T-2.9 T and 7 mm-30 mm, respectively, and most preferably, the ranges are 0.8 T-1.5 T and 13 mm-26 mm, respectively. Here, the notation indicating a numerical range such as “0.5 T-3.0 T” indicates a range including the numerical values shown before and after “-”. For example, the notation of “0.5 T-3.0 T” means “0.5 T or more and 3.0 T or less”.

When the Faraday material 135 is the quartz crystal and the wavelength of the pulse laser light is 193 nm, which is the oscillation wavelength of the ArF excimer laser, the selectable ranges of the magnetic field applied to the Faraday rotator 112 and the thickness of the Faraday material 135 in the optical axis direction are 0.5 T-3.0 T and 3 mm-25 mm, respectively. More preferably, the ranges are 0.75 T-2.9 T and 6 mm-20 mm, respectively, and most preferably, the ranges are 0.8 T-1.5 T and 8 mm-15 mm, respectively.

Further, as shown in FIG. 6, when the Faraday material 135 is MgF₂ and the wavelength of the pulse laser light is 248 nm, which is the oscillation wavelength of the KrF excimer laser, the selectable ranges of the magnetic field applied to the Faraday rotator 112 and the thickness of the Faraday material 135 in the optical axis direction are 0.5 T-3.0 T and 13 mm-83 mm, respectively. More preferably, the ranges are 0.75 T-2.9 T and 14mm-55mm, respectively, and most preferably, the ranges are 0.8 T-1.5 T and 27 mm-52 mm, respectively.

When the Faraday material 135 is the quartz crystal and the wavelength of the pulse laser light is 248 nm, which is the oscillation wavelength of the KrF excimer laser, the selectable ranges of the magnetic field applied to the Faraday rotator 112 and the thickness of the Faraday material 135 in the optical axis direction are 0.5 T-3.0 T and 8 mm-53mm, respectively. More preferably, the ranges are 0.75 T-2.9 T and 10 mm-40 mm, respectively, and most preferably, the ranges are 0.8 T-1.5 T and 15 mm-30 mm, respectively.

Here, the Faraday material 135 may be divided into a plurality of pieces, and the total thickness of these pieces may satisfy the above thickness. The number of divisions may be, for example, two, three, or four.

### 4.5 Allowable Angular Difference Between Transmission Axis of Polarizer and Polarization Direction of Laser Light

It is most preferable that the transmission axis of each of the first polarizer 83 and the second polarizer 88 is parallel to the polarization direction of the pulse laser light to be incident on each polarizer, but not limited to the case in which they are strictly parallel, each angular difference is allowed within a range in which an intended function can be practically achieved.

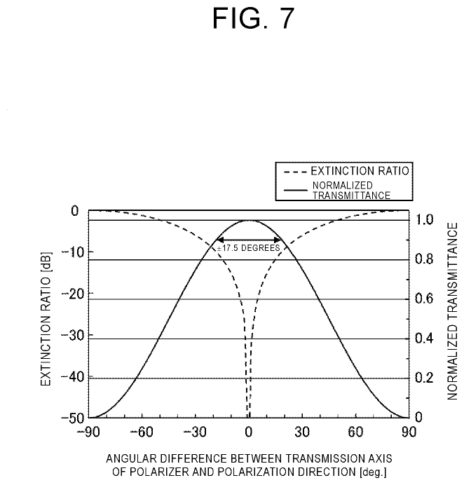

FIG. 7 shows a graph showing the relationship between the angular difference between the transmission axis of the polarizer and the polarization direction of the pulse laser light and the extinction ratio (dB), and a graph obtained by converting the extinction ratio into a normalized transmittance. The vertical axis on the left side of FIG. 7 represents the extinction ratio, and the vertical axis on the right side represents the normalized transmittance. The normalized transmittance is a value normalized such that the transmittance when the angular difference is 0 degrees becomes 1.0. In each of the first polarizer 83 that transmits the pulse laser light output from the first Faraday rotator 110 and the second polarizer 88 that transmits the pulse laser light output from the second Faraday rotator 112, when the normalized transmittance with respect to the incident pulse laser light is 0.9 or more, the polarizer can function effectively in practical use. Therefore, according to FIG. 7, a preferable allowable range of the angular difference between the transmission axis of the first polarizer 83 or the second polarizer 88 and the polarization direction of the pulse laser light is a range of ±17.5 degrees in which the normalized transmittance is 0.9 or more.

### 4.6 Effect

According to the optical isolator 120 of the first embodiment, the polarization direction of the pulse laser light can be maintained the same before and after the transmission through the optical isolator 120 without using the half-wave plate 81 having low durability at short wavelengths. Therefore, it is possible to suppress the return light without changing other modules depending on the polarization direction.

### 4.7 Modification

In FIG. 4, description has been provided on an example in which the polarization plane is rotated by 45 degrees due to the Faraday effect of the Faraday material 135 and the polarization plane is rotated by 45+(180×n) degrees in the opposite direction due to optical activity or birefringence with respect to the going light. However, not limited to this example, the range of the rotation angle of the both is allowed within a range in which the intended function can be practically achieved. According to FIG. 7, the rotation amount of the polarization plane due to the Faraday effect of the Faraday material 135 with respect to the going light may be within a range of 45±17.5 degrees, and the rotation amount of the polarization plane due to optical activity or birefringence may be within a range of 45+(180×n)±17.5 degrees.

Further, in FIG. 4, description has been provided on an example in which the polarization direction of the going light that is transmitted through the first polarizer 83 and enters the Faraday rotator 112 is maintained the same before and after the transmission through the Faraday rotator 112, and the polarization direction, of the returning light that is transmitted through the second polarizer 88 and enters the Faraday rotator 112, after the transmission through the Faraday rotator 112 is rotated by 90 degrees with respect to that before the transmission therethrough, but the present invention is not limited to this example, and the angular difference between the polarization directions before and after the transmission through the Faraday rotator 112 is allowed within a range in which the target function can be practically achieved. According to FIG. 7, for the going light that is transmitted through the first polarizer 83 and enters the Faraday rotator 112, the polarization direction is maintained before and after the transmission through the Faraday rotator 112 with the angular difference being equal to or less than 17.5 degrees, and for the returning light that is transmitted through the second polarizer 88 and enters the Faraday rotator 112, the polarization direction after the transmission through the Faraday rotator 112 may be rotated by an angle within a range of 90±17.5 degrees with respect to that before the transmission therethrough. With the configuration in which the polarization direction of the going light incident on the first polarizer 83 and the polarization direction when the returning light returning from the PO 26 is transmitted through the Faraday rotator 112 and enters the first polarizer 83 intersect at an angle within a range of 90±17.5 degrees, the return light is reflected by the first polarizer 83 and is suppressed from entering the MO 22.

### 5. Second Embodiment

### 5.1 Configuration

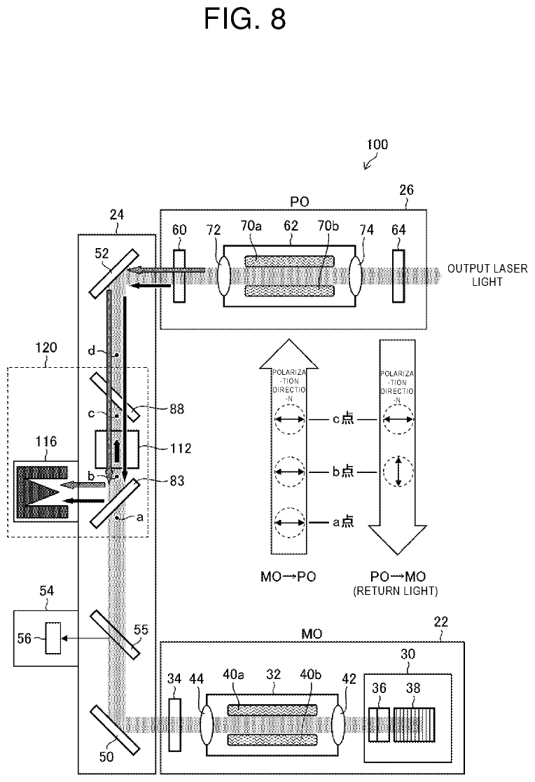

FIG. 8 schematically shows a configuration example of an ultraviolet laser device 100 according to a second embodiment. The configuration shown in FIG. 8 will be described in terms of differences from the configuration shown in FIG. 1. The ultraviolet laser device 100 is different from the configuration of FIG. 1 in that the optical isolator 120 is arranged on the optical path between the MO 22 and the PO 26. The optical isolator 120 includes the first polarizer 83, the Faraday rotator 112, and the second polarizer 88, as described in the first embodiment.

The optical isolator 120 further includes a damper 116 for terminating the return light. The damper 116 is arranged such that the return light reflected by the first polarizer 83 is incident on the damper 116. Other configurations may be similar to those in FIG. 1.

In FIG. 8, the polarization directions of the pulse laser light at points a, b, and c on the optical path between the MO 22 and the PO 26 are also shown. FIG. 8 shows the polarization directions at points a to c of the pulse laser light propagating from the MO 22 toward the PO 26, and polarization directions at points c and b of the return light returning from the PO 26 toward the MO 22.

### 5.2 Operation

Operation of the optical isolator 120 is similar to that in the first embodiment. The pulse laser light (point a) output from the MO 22 and polarized in a specific direction is transmitted through the first polarizer 83 (point b). The pulse laser light having transmitted through the first polarizer 83 is incident on the Faraday rotator 112, and is output from the Faraday rotator 112 (point c) while the polarization direction is maintained the same before and after the Faraday rotator 112. The pulse laser light output from the Faraday rotator 112 is transmitted through the second polarizer 88. The polarization direction of the pulse laser light traveling from the MO 22 to the PO 26 at point a is the same as the polarization direction at point d.

Regarding the return light returning in the direction from the PO 26 to the MO 22, at point d in FIG. 4, the polarization direction of the pulse laser light propagating in the direction from the MO 22 to the PO 26 is the same as the polarization direction of the pulse laser light (return light) returning in the direction from the PO 26 to the MO 22. Therefore, the return light returning from the PO 26 to the MO 22 is transmitted through the second polarizer 88 (point c).

The polarization direction of the return light having transmitted through the second polarizer 88 is rotated by 90 degrees by the Faraday rotator 112 (point b). At point b, the polarization direction of the pulse laser light propagating in the direction from the MO 22 to the PO 26 is perpendicular to the polarization direction of the pulse laser light returning in the direction from the PO 26 to the MO 22. Therefore, the pulse laser light returning in the direction from the PO 26 to the MO 22 is reflected by the first polarizer 83 and is incident on the damper 116. The damper 116 absorbs and blocks the light reflected by the first polarizer 83.

### 5.3 Effect

According to the ultraviolet laser device 100 of the second embodiment, the polarization direction can be maintained the same before and after the transmission through the optical isolator 120 without using the half-wave plate 81 having low durability at short wavelengths. Therefore, it is possible to suppress the return light without changing other modules depending on the polarization direction.

Further, according to the ultraviolet laser device 100 of the second embodiment, the pulse laser light returning in the direction from the PO 26 to the MO 22 is reflected by the first polarizer 83 and absorbed by the damper 116, so that the pulse laser light is suppressed from entering the MO 22. As a result, thermal load on the MO 22 is reduced, and energy stability, line width stability, and the like are improved compared with the configuration of the comparative example.

### 5.4 Modification

The MO pulse energy monitor 54 may be arranged on either the upstream side or the downstream side of the optical isolator 120. However, the configuration of arranging on the upstream side of the optical isolator 120 as shown in FIG. 8 is preferable.

### 6. Third Embodiment

### 6.1 Configuration

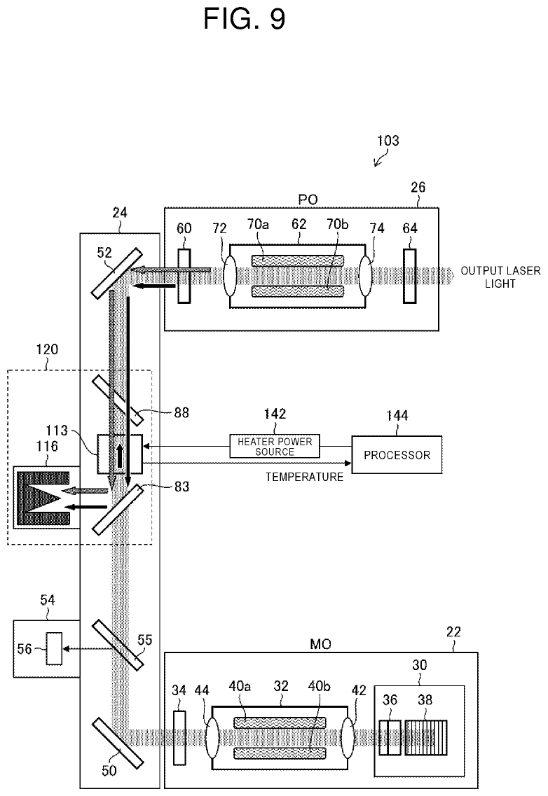

FIG. 9 schematically shows the configuration of an ultraviolet laser device 103 according to a third embodiment. The configuration shown in FIG. 9 will be described in terms of differences from the configuration shown in FIG. 8. The ultraviolet laser device 103 according to the third embodiment is different from the configuration of the second embodiment in that a temperature-adjustable Faraday rotator 113 is used in place of the Faraday rotator 112 of the second embodiment, and the temperature of the Faraday rotator 113 is controlled to a constant temperature.

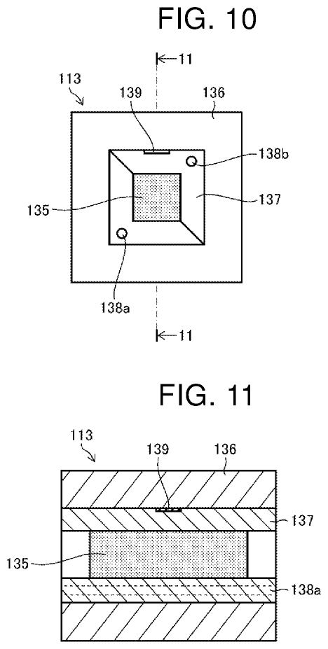

FIG. 10 is a front view schematically showing the configuration of the Faraday rotator 113, and FIG. 11 is a sectional view taken along line 11-11 of FIG. 10. The Faraday material 135 is held by a holder 137 and is arranged inside the magnet 136 having a hollow structure. The Faraday rotator 113 includes heaters 138a, 138b and a temperature sensor 139. The heaters 138a, 138b and the temperature sensor 139 are attached to the holder 137. The heaters 138a, 138b are preferably arranged at symmetrical positions with the Faraday material 135 interposed therebetween to extend in parallel to the optical axis direction. The temperature sensor 139 detects the temperature of the Faraday rotator 113.

The ultraviolet laser device 103 includes a heater power source 142 and a processor 144 that controls the temperature of the Faraday rotator 113 (see FIG. 9). The heater power source 142 supplies power to the heaters 138a, 138b.

The processor 144 controls the heater power source 142 to keep the temperature of the Faraday rotator 113 constant based on the information obtained from the temperature sensor 139. Here, the description of “keep constant” includes keeping within an allowable range. The processor 144 controls the heaters 138a, 138b via the heater power source 142 to suppress temperature changes of the Faraday material 135. The processor 144 is a processing device including a storage device in which a control program is stored and a central processing unit (CPU) that executes the control program.

### 6.2 Operation

The processor 144 drives the heaters 138a, 138b via the heater power source 142, monitors the temperature of the Faraday rotator 113 using the temperature sensor 139, and adjusts the temperature of the Faraday rotator 113 to maintain a predetermined temperature. The predetermined temperature is, for example, preferably room temperature being 100° C. or less. Other operations are similar to those in the second embodiment.

### 6.3 Effect

According to the ultraviolet laser device 103 of the third embodiment, similar effects to those of the second embodiment can be obtained. Further, according to the configuration of the third embodiment, it is possible to prevent the Faraday material 135 from changing in temperature due to a change in environmental temperature, absorption of laser light, and the like. As a result, the change in the optical path length due to the temperature change is suppressed, the rotation angle of the polarization can be maintained constant, and the decrease in the transmittance of the polarizer and the deterioration in the isolation ratio can be suppressed.

### 7. Fourth Embodiment

### 7.1 Configuration

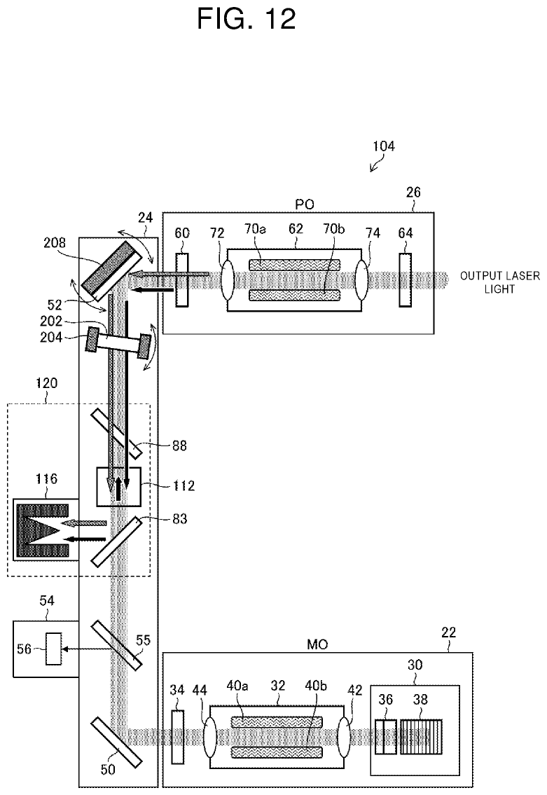

FIG. 12 schematically shows the configuration of an ultraviolet laser device 104 according to a fourth embodiment. The configuration shown in FIG. 12 will be described in terms of differences from the configuration shown in FIG. 8. The ultraviolet laser device 104 shown in FIG. 12 is different from the configuration shown in FIG. 8 in that a two-axis adjustable plane-parallel substrate 202 and a two-axis adjustable high reflection mirror 52 are arranged on the optical path between the second polarizer 88 and the PO 26. The plane-parallel substrate 202 is held by a two-axis angle adjustment holder 204 capable of adjusting an angle with each of two axes perpendicular to each other as a rotation axis.

The plane-parallel substrate 202 is arranged on the optical path between the second polarizer 88 and the high reflection mirror 52. The plane-parallel substrate 202 may be a substrate of calcium fluoride. The two-axis angle adjustment holder 204 may be, for example, a holder capable of adjusting angles using, as rotation axes, an axis perpendicular to the paper surface of FIG. 12 and an axis parallel to both the substrate surface of the plane-parallel substrate 202 and the paper surface of FIG. 12, respectively.

The high reflection mirror 52 is held by a two-axis angle adjustment holder 208 capable of adjusting the angle with each of two axes perpendicular to each other as a rotation axis. The two-axis angle adjustment holder 208 may be, for example, a holder capable of adjusting angles using, as rotation axes, an axis perpendicular to the paper surface of FIG. 12 and an axis parallel to both the reflection surface of the high reflection mirror 52 and the paper surface of FIG. 12, respectively.

### 7.2 Operation

The adjustment of the optical axis is performed by adjusting the two-axis adjustable plane-parallel substrate 202 and the two-axis adjustable high reflection mirror 52 so that the pulse laser light from the MO 22 enters the PO 26 most efficiently.

The two-axis adjustable plane-parallel substrate 202 is adjusted so that the pulse laser light enters the PO 26 most efficiently by shifting the pulse laser light from the MO 22 in parallel to the travel direction.

The two-axis adjustable high reflection mirror 52 is adjusted so that the pulse laser light enters the PO 26 most efficiently by changing the incident angle of the pulse laser light from the MO 22 on the PO 26.

Each of the two-axis angle adjustment holder 204 and the two-axis angle adjustment holder 208 is an example of the “optical axis adjustment mechanism” in the present disclosure. Although a configuration including both the two-axis adjustable plane-parallel substrate 202 and the two-axis adjustable high reflection mirror 52 is preferable, a configuration including only one of them is also possible.

### 7.3 Effect

According to the ultraviolet laser device 104 of the fourth embodiment, similar effects to those of the second embodiment can be obtained. Further, according to the configuration of the fourth embodiment, the optical axis of the injection light to be incident on the PO 26 is easily adjusted as compared with the configuration of the second embodiment.

### 8. Fifth Embodiment

### 8.1 Configuration

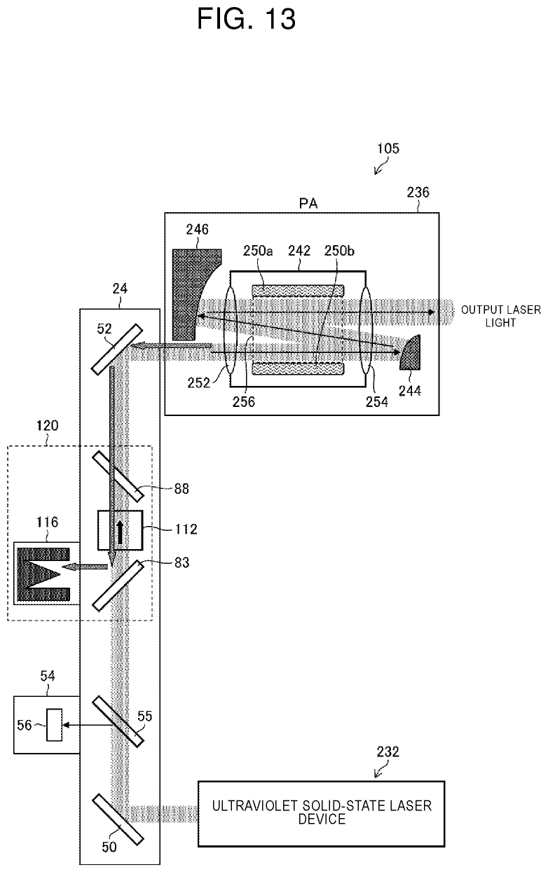

FIG. 13 schematically shows the configuration of an ultraviolet laser device 105 according to a fifth embodiment. The configuration shown in FIG. 13 will be described in terms of differences from the configuration shown in FIG. 8. The ultraviolet laser device 105 shown in FIG. 13 includes an ultraviolet solid-state laser device 232 as an oscillation stage laser in place of the MO 22 shown in FIG. 8, and includes an excimer amplifier 236 in place of the PO 26. Other configurations may be similar to those shown in FIG. 8

The ultraviolet solid-state laser device 232 outputs, for example, a fourth harmonic, a fifth harmonic, or a sixth harmonic (ranging from a wavelength of 150 nm to 380 nm) of the solid-state laser having a near-infrared band (wavelength of 780 nm to 2500 nm) as a fundamental wave. For example, the ultraviolet solid-state laser device 232 is arranged to output seed light having a wavelength of about 193 nm and cause the seed light to enter the excimer amplifier 236.

As an example, the ultraviolet solid-state laser device 232 may include a semiconductor laser system, a titanium sapphire amplifier, and a wavelength conversion system. The semiconductor laser system may be configured to include a distributed feedback (DFB) semiconductor laser that outputs CW laser light having a wavelength of about 773.6 nm, and a semiconductor optical amplifier (SOA) that turns the CW laser light into pulses. The wavelength conversion system includes a plurality of nonlinear optical crystals, and performs wavelength conversion on the incident pulse laser light to output pulse laser light of fourth harmonic. The wavelength conversion system includes, for example, an LBO crystal and a KBBF crystal. The LBO crystal is a nonlinear optical crystal represented by the chemical formula LiB₃O₅. The KBBF crystal is a nonlinear optical crystal represented by the chemical formula KBe₂BO₃F₂.

The excimer amplifier 236 includes a chamber 242, a convex cylindrical mirror 244, and a concave cylindrical mirror 246.

The chamber 242 includes a pair of discharge electrodes 250a, 250b and two windows 42, 44 through which the laser light is transmitted. The discharge electrodes 250a, 250b are arranged to face each other with a discharge space 256 interposed therebetween. The space between the discharge electrodes 250a, 250b is the discharge space 256. The direction in which the discharge electrodes 250a, 250b face each other across the discharge space 256 corresponds to the discharge direction. The chamber 242 is filled with a laser gas similar to the laser gas described with reference to FIG. 8.

The convex curved surface of the convex cylindrical mirror 244 and the concave curved surface of the concave cylindrical mirror 246 are each coated with a high reflection film for a wavelength of about 193 nm.

The convex cylindrical mirror 244 and the concave cylindrical mirror 246 are arranged such that the seed light from the ultraviolet solid-state laser device 232 is beam-expanded in the discharge direction and amplified as passing through the discharge space 256 of the excimer amplifier 236 three times.

### 8.2 Operation

The seed light output from the ultraviolet solid-state laser device 232 is transmitted through the optical isolator 120 and enters the excimer amplifier 236. The seed light having a wavelength of about 193 nm entering the excimer amplifier 236 is reflected by the convex cylindrical mirror 244 and the concave cylindrical mirror 246, and passes through the discharge space 256 between the discharge electrodes 250a, 250b three times. Thus, the beam of the seed light is expanded and amplified. The excimer amplifier 236 is an example of the “multipass amplifier” in the present disclosure. Not only the three-pass excimer amplifier 236 but also various multipass amplifiers can be used.

The operation of the optical isolator 120 is similar to that in the first embodiment described with reference to FIG. 8. The optical isolator 120 suppresses amplified spontaneous emission (ASE) and the like occurring at the excimer amplifier 236 from entering the ultraviolet solid-state laser device 232.

### 8.3 Effect

According to the ultraviolet laser device 105 of the fifth embodiment, the polarization direction can be maintained the same before and after the transmission through the optical isolator 120 without using the half-wave plate 81 having low durability at short wavelengths. Therefore, it is possible to suppress the return light without changing other modules depending on the polarization direction.

According to the ultraviolet laser device 105 of the fifth embodiment, since the light returning in the direction from the excimer amplifier 236 to the ultraviolet solid-state laser device 232 does not enter the ultraviolet solid-state laser device 232, the thermal load on the ultraviolet solid-state laser device 232 is reduced, and the energy stability, the line width stability, and the like are improved compared with the configuration of the comparative example.

### 9. Sixth Embodiment

### 9.1 Configuration

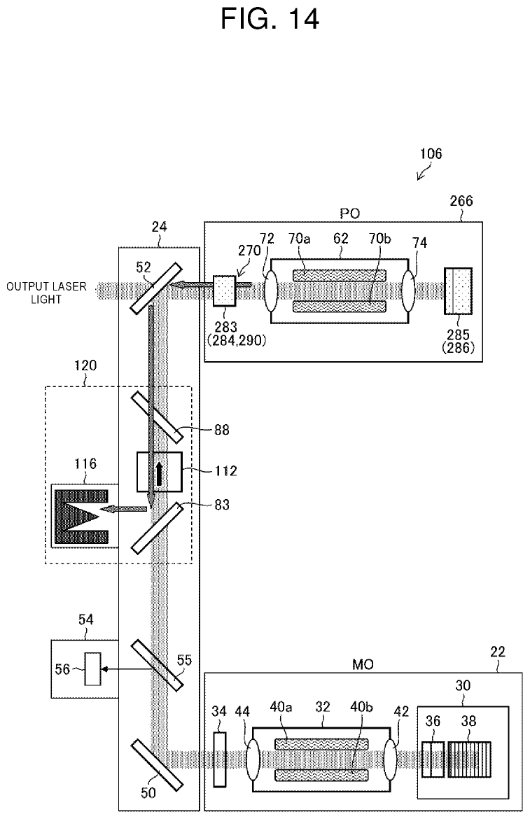

FIG. 14 schematically shows the configuration of an ultraviolet laser device 106 according to a sixth embodiment. The configuration shown in FIG. 14 will be described in terms of differences from the configuration shown in FIG. 8. The ultraviolet laser device 106 according to the sixth embodiment is different from the configuration of the first embodiment in the configuration of the amplification stage laser and the configuration of the high reflection mirror that introduces the laser light from the MO 22 into the amplification stage laser.

The amplification stage laser of the second embodiment shown in FIG. 8 is the PO 26 having a Fabry-Perot optical resonator configured by the rear mirror 60 and the output coupling mirror 64, whereas the amplification stage laser of the sixth embodiment shown in FIG. 14 is a PO 266 having a ring resonator 270.

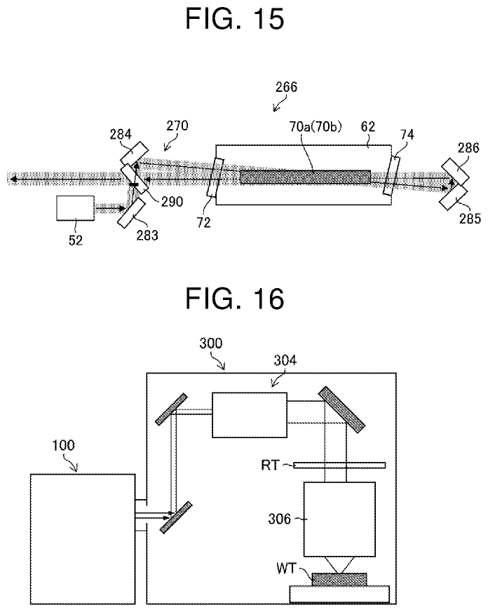

FIG. 15 is a top view schematically showing the configuration of the PO 266 applied to the sixth embodiment. The ring resonator 270 includes a high reflection mirror 284, a high reflection mirror 285, a high reflection mirror 286, and a partial reflection mirror 290.

In the ultraviolet laser device 106, a high reflection mirror 283 is arranged to introduce the laser light output from the MO 22 and reflected by the high reflection mirror 50 and the high reflection mirror 52 into the ring resonator 270. The high reflection mirror 283 is arranged on the optical path between the high reflection mirror 52 and the partial reflection mirror 290 so that the laser light reflected by the high reflection mirror 52 enters the partial reflection mirror 290.

### 9.2 Operation

The laser light output from the MO 22 is sequentially reflected by the high reflection mirror 50, the high reflection mirror 52, and the high reflection mirror 283, and then enters the ring resonator 270 via the partial reflection mirror 290.

The laser light transmitted through the partial reflection mirror 290 is reflected by the high reflection mirror 284, enters the chamber 62, and is amplified. Thereafter, the laser light is reflected by the high reflection mirror 285 and the high reflection mirror 286, enters the chamber 62 again, and is amplified. Then, a part of the laser light output from the chamber 62 is transmitted through the partial reflection mirror 290, and the other part thereof is reflected and amplified again by the ring resonator 270.

The amplified pulse laser light transmitted through the partial reflection mirror 290 is output from the ultraviolet laser device 106.

The optical isolator 120 suppresses return light from the PO 266 from entering the MO 22. The operation of the optical isolator 120 is similar to that in the second embodiment described with reference to FIG. 8.

### 9.3 Effect

According to the ultraviolet laser device 106 of the sixth embodiment, similar effects to those of the second embodiment can be obtained.

### 10. Electronic Device Manufacturing Method

FIG. 16 schematically shows a configuration example of an exposure apparatus 300. The exposure apparatus 300 includes an illumination optical system 304 and a projection optical system 306. The illumination optical system 304 illuminates a reticle pattern of a reticle (not shown) arranged on a reticle stage RT with the laser light incident from the ultraviolet laser device 100. The projection optical system 306 causes the laser light transmitted through the reticle to be imaged as being reduced and projected on a workpiece (not shown) arranged on a workpiece table WT. The workpiece is a photosensitive substrate such as a semiconductor wafer on which photoresist is applied.

The exposure apparatus 300 synchronously translates the reticle stage RT and the workpiece table WT to expose the workpiece to the laser light reflecting the reticle pattern. After the reticle pattern is transferred onto the semiconductor wafer by the exposure process described above, a semiconductor device can be manufactured through a plurality of processes. The semiconductor device is an example of the “electronic device” in the present disclosure. Instead of the ultraviolet laser device 100, the ultraviolet laser device 103, 104, 105, or 106 described in the third to sixth embodiment may be used to generate the laser light.

### 11. Other Application Examples of Optical Isolator

The optical isolator 120 exemplified in the first to sixth embodiments can be applied not only to the ultraviolet laser device but also to various applications. For example, the incident light to the optical isolator 120 is not limited to the pulse laser light, and may be CW laser light or radiation light. For example, the optical isolator 120 may be located at the outlet of the radiation light at an accelerator. Further, the optical isolator 120 may be arranged to suppress stray light having a wavelength in the ultraviolet region in a spectroscope using a deuterium lamp.

### 12. Others

The description above is intended to be illustrative and the present disclosure is not limited thereto. Therefore, it would be obvious to those skilled in the art that various modifications to the embodiments of the present disclosure would be possible without departing from the spirit and the scope of the appended claims. Further, it would be also obvious to those skilled in the art that embodiments of the present disclosure would be appropriately combined.

The terms used throughout the present specification and the appended claims should be interpreted as non-limiting terms unless clearly described. For example, terms such as “comprise”, “include”, “have”, and “contain” should not be interpreted to be exclusive of other structural elements. Further, indefinite articles “a/an” described in the present specification and the appended claims should be interpreted to mean “at least one” or “one or more.” Further, “at least one of A, B, and C” should be interpreted to mean any of A, B, C, A+B, A+C, B+C, and A+B+C as well as to include combinations of the any thereof and any other than A, B, and C.

What is claimed is:

1. An optical isolator comprising:
a first polarizer arranged such that a transmission axis thereof is set to cause a normalized transmittance with respect to incident light having a wavelength of ultraviolet and linear polarization to be 0.9 or more;
a Faraday rotator using a Faraday material configured to rotate a polarization direction of light having transmitted through the first polarizer in a first rotation direction by a first rotation amount by a magnetic field and rotate the polarization direction in a second rotation direction opposite to the first rotation direction by a second rotation amount by optical activity or birefringence; and
a second polarizer arranged such that a transmission axis thereof is set to cause a normalized transmittance with respect to the incident light having transmitted through the Faraday rotator to be 0.9 or more.

2. The optical isolator according to claim 1,
wherein an angular difference between the polarization direction of the incident light and the transmission axis of the first polarizer is equal to or less than 17.5 degrees, and
an angular difference between the polarization direction of the incident light having transmitted through the Faraday rotator and the transmission axis of the second polarizer is equal to or less than 17.5 degrees.

3. The optical isolator according to claim 1,
wherein the first rotation amount is within a range of 45±17.5 degrees, and the second rotation amount is within a range of 45+(180×n)±17.5 degrees, where n is an integer.

4. The optical isolator according to claim 1,
wherein the polarization direction of the incident light traveling from the first polarizer to the second polarizer is maintained before and after transmission through the Faraday rotator with an angular difference being equal to or less than 17.5 degrees,
a polarization direction of return light traveling from the second polarizer to the first polarizer after transmission through the Faraday rotator is rotated by an angle within a range of 90.5±17.5 degrees with respect to that before the transmission, and
the return light is reflected by the first polarizer.

5. The optical isolator according to claim 1,
wherein the Faraday material is a quartz crystal or magnesium fluoride.

6. The optical isolator according to claim 1,
wherein a wavelength of the incident light is an oscillation wavelength of an ArF excimer laser or an oscillation wavelength of a KrF excimer laser.

7. The optical isolator according to claim 1,
wherein a flux density of the magnetic field applied to the Faraday rotator is 0.5 T or more and 3.0 T or less.

8. The optical isolator according to claim 7,
wherein the Faraday material is magnesium fluoride, and
when a wavelength of the incident light is an oscillation wavelength of the ArF excimer laser, thickness of the Faraday material in an optical axis direction is 6 mm or more and 42 mm or less.

9. The optical isolator according to claim 7,
wherein the Faraday material is magnesium fluoride, and
when a wavelength of the incident light is an oscillation wavelength of the KrF excimer laser, thickness of the Faraday material in an optical axis direction is 13 mm or more and 83 mm or less.

10. The optical isolator according to claim 7,
wherein the Faraday material is a quartz crystal, and
when a wavelength of the incident light is an oscillation wavelength of the ArF excimer laser, thickness of the Faraday material in an optical axis direction is 3 mm or more and 25 mm or less.

11. The optical isolator according to claim 7,
wherein the Faraday material is a quartz crystal, and
when a wavelength of the incident light is an oscillation wavelength of the KrF excimer laser, thickness of the Faraday material in an optical axis direction is 8 mm or more and 53 mm or less.

12. The optical isolator according to claim 1,
wherein the Faraday material is configured of a plurality of divided materials.

13. The optical isolator according to claim 1,
wherein the Faraday rotator includes a heater and a temperature sensor, and
a temperature of the Faraday material is controlled to be kept constant.

14. An ultraviolet laser device comprising:
an oscillation stage laser configured to output pulse laser light having a wavelength of ultraviolet and linear polarization;
an amplifier configured to amplify and output the pulse laser light; and
an optical isolator arranged on an optical path between the oscillation stage laser and the amplifier,
the optical isolator including:
a first polarizer arranged such that a transmission axis thereof is set to cause a normalized transmittance with respect to the pulse laser light output from the oscillation stage laser to be 0.9 or more;
a Faraday rotator using a Faraday material configured to rotate a polarization direction of the pulse laser light having transmitted through the first polarizer in a first rotation direction by a first rotation amount by a magnetic field and rotate the polarization direction in a second rotation direction opposite to the first rotation direction by a second rotation amount by optical activity or birefringence; and
a second polarizer arranged such that a transmission axis thereof is set to cause a normalized transmittance with respect to the pulse laser light having transmitted through the Faraday rotator to be 0.9 or more.

15. The ultraviolet laser device according to claim 14, comprising:
a heater arranged at the Faraday rotator,
a temperature sensor configured to detect a temperature of the Faraday rotator, and
a processor configured to control the heater, based on information from the temperature sensor, so that temperature change of the Faraday material is suppressed.

16. The ultraviolet laser device according to claim 14, comprising:
an optical axis adjustment mechanism, between the second polarizer and the amplifier, including an adjustment mechanism to perform adjustment about at least two axes.

17. The ultraviolet laser device according to claim 14,
wherein each of the oscillation stage laser and the amplifier includes a chamber filled with a laser gas.

18. The ultraviolet laser device according to claim 14,
wherein the oscillation stage laser is an ultraviolet solid-state laser.

19. The ultraviolet laser device according to claim 14,
wherein the amplifier has a configuration including a resonator or is a multipass amplifier.

20. An electronic device manufacturing method, comprising:
generating laser light amplified by an amplifier using an ultraviolet laser device;
outputting the amplified laser light to an exposure apparatus; and
exposing a photosensitive substrate to the laser light in the exposure apparatus to manufacture an electronic device,
the ultraviolet laser device including:
an oscillation stage laser configured to output pulse laser light having a wavelength of ultraviolet and linear polarization;
the amplifier configured to amplify and output the pulse laser light; and
an optical isolator arranged on an optical path between the oscillation stage laser and the amplifier,
and the optical isolator including:
a first polarizer arranged such that a transmission axis thereof is set to cause a normalized transmittance with respect to the pulse laser light output from the oscillation stage laser to be 0.9 or more;
a Faraday rotator using a Faraday material configured to rotate a polarization direction of the pulse laser light having transmitted through the first polarizer in a first rotation direction by a first rotation amount by a magnetic field and rotate the polarization direction in a second rotation direction opposite to the first rotation direction by a second rotation amount by optical activity or birefringence; and
a second polarizer arranged such that a transmission axis thereof is set to cause a normalized transmittance with respect to the pulse laser light having transmitted through the Faraday rotator to be 0.9 or more.
